(19) United States
(12) Patent Application Publication
(10) Pub. No.: US 2015/0011395 A1
(43) Pub. Date: Jan. 8, 2015

(54) SUPERCONDUCTING MAGNETIC SUSPENSION DEVICE HAVING NO LIQUID HELIUM VOLATILIZATION

(71) Applicant: Institute of Electrical Engineering, Chinese Academy of Sciences, Beijing (CN)

(72) Inventors: Xinning Hu, Beijing (CN); Qiuliang Wang, Beijing (CN); Yinming Dai, Beijing (CN); Baozhi Zhao, Beijing (CN); Hui Wang, Beijing (CN); Chunyan Cui, Beijing (CN)

(73) Assignee: Institute of Electrical Engineering, Chinese Academy of Sciences, Beijing (CN)

(21) Appl. No.: 14/375,399

(22) PCT Filed: Sep. 27, 2012
(86) PCT No.: PCT/CN2012/082107

§ 371 Date: Jul. 29, 2014

(30) Foreign Application Priority Data
Feb. 2, 2012 (CN) 201210023048.5

(51) Int. Cl. H01F 6/04; H01F 6/06; F25D 3/10

(52) U.S. Cl. CPC H01F 6/04; F25D 3/10; H01F 6/06
USPC 505/163; 62/51.1

(57) ABSTRACT

A free liquid helium volatilization superconductive magnetic suspension device includes a low temperature container, a refrigeration, a cold screen, a liquid helium container, a superconductive rotor, a suspension coil, a rotor chamber, a liquid tube, a condenser and a pole-axis displacement sensor. The heat generated by the wires of the suspension coil can be prevented transferring to the liquid helium container by the room temperature current lead joint, the high temperature superconducting current lead joint and low temperature superconducting current lead joint. Therefore the volatilization of the liquid helium in the liquid helium container can be reduced. The status of free liquid helium volatilization in the liquid helium container can be reached through refrigeration cooling condenser to liquefy the helium. The device needs not to be input the liquid helium time after time and can run independently for a long term.

### CROSS-REFERENCE TO RELATED APPLICATIONS

This application claims priority under 35 U.S.C. §371 to, and is a U.S. national phase application of, International Application No. PCT/CN2012/082107, filed Sep. 27, 2012, entitled “FREE LIQUID HELIUM VOLATILIZATION SUPERCONDUCTIVE MAGNETIC SUSPENSION DEVICE,” which claims priority to Chinese Application No. 201210023048.5, filed Feb. 2, 2012, the disclosure of each is incorporated herein by reference in its entirety.

### TECHNICAL FIELD

This disclosure relates to the superconductor field, particularly to a superconducting magnetic suspension device having no liquid helium volatilization.

### DESCRIPTION OF THE RELATED ART

With the continuous development of superconducting material and low temperature techniques, superconducting techniques have found wider and wider applications in various fields, leading to continuous satisfaction in the requirement of industrial modernization and great improvement of the performance and accuracy of various kinds of equipment. Low temperature devices are necessary devices to realize superconducting low temperature environments. The performance and research of low temperature devices is the foundation of and thus is significant in the development of superconducting instrument and equipment.

The development of refrigerators and conduction cooling techniques provided more opportunities in terms of the selection of structures and application scenarios of low temperature equipment. Nowadays, the temperature of secondary cooling heads of refrigerators may be lower than 4K.

Superconducting temperature area may be divided into a high temperature area and a low temperature area. A temperature area generally below 10K in which superconductivity may be realized is referred as a low temperature area, and a temperature area up to 100K above 10K in which superconductivity may be realized is referred as a high temperature area. According to different application scenarios and requirements, low temperature equipment may adopt liquid helium cooling, refrigerant cooling or refrigerant and liquid helium cooling. For low temperature equipment adopting merely liquid helium cooling, there is a higher design requirement in terms of heat leakage. Further, the process of liquid conveying that must be performed several times is tedious, causing high cost for a long term operation. A Chinese patent ZL 01226956.5 discloses a magnetic suspension device adopting liquid helium cooling, in which heat leakage may cause liquid helium volatilization. As a result, liquid helium has to be supplied regularly to maintain a low temperature environment, making the long term independent operation of the device impossible.

### SUMMARY

One object of this disclosure is to provide a superconducting magnetic suspension device having no liquid helium volatilization capable of achieving zero volatilization of liquid helium in a liquid helium container, so that it is not necessary to perform liquid helium conveying several times, enabling the superconducting magnetic suspension device to operate independently for a long period of time accordingly.

A technical solution adopted in the present disclosure is a superconducting magnetic suspension device having no substantial liquid helium volatilization, comprising: a low temperature container, a refrigerator, and a cold screen, wherein the refrigerator is mounted above the low temperature container, and the cylindrical cold screen is fixed under a primary cooling head of the refrigerator, wherein: the superconducting magnetic suspension device further comprises a liquid helium container, a superconducting rotor, suspension coils, a rotor chamber, a liquid tube, a room temperature current lead joint, a high temperature superconducting current lead joint, a low temperature superconducting current lead joint, a condenser, and a pole-axis displacement sensor; the liquid helium container is placed in the cold screen and is fixed under a secondary cooling head of the refrigerator; the liquid tube is mounted above the liquid helium container with a lower end of the liquid tube extending into the liquid helium container; the superconducting rotor is arranged in the rotor chamber, and the suspension coils are arranged on the upper and lower ends within the rotor chamber; the pole-axis displacement sensor is placed at a center position on the top of the superconducting rotor within the rotor chamber, a probe of the pole-axis displacement sensor pointing downwards to a top plane of the superconducting rotor; the rotor chamber is held at the center of the liquid helium container by a pull rod; the condenser is placed at a center position above the rotor chamber in the interior of the liquid helium container; the room temperature current lead joint is mounted on the top surface of the low temperature container; a lead on an upper side of the room temperature current lead joint is connected to a power source and a lead on an lower side of the room temperature current lead joint is connected to a lead on an upper side of the high temperature superconducting current lead joint; the high temperature superconducting current lead joint is mounted on the top surface of the cold screen and is cooled by the cold screen, so that the current lead of the high temperature superconducting current lead joint is in a superconducting state; a lead on a lower side of the high temperature superconducting current lead joint is connected to a lead on an upper side of the low temperature superconducting current lead joint, the low temperature superconducting current lead joint is mounted on an upper cover of the liquid helium container; the low temperature superconducting current lead joint is cooled by the liquid helium container, so that the current lead of the low temperature superconducting current lead joint is in a superconducting state; a lead on a lower side of the low temperature superconducting current lead joint is connected to the suspension coils.

In the superconducting magnetic suspension device described above, the condenser has a cylindrical shape, multiple rectangular heat-conducting splines that are separated by gaps are provided in the condenser; a plurality of air vents are provided in the external surface of the condenser and the heat-conducting splines; and the condenser is formed of a metal material.

In the superconducting magnetic suspension device described above, the current leads of the room temperature current lead joint are formed of metal wires, the current leads of the high temperature superconducting current lead joint are formed of high temperature superconducting bars, and the current leads of the low temperature superconducting current lead joint are formed of low temperature superconducting wires.

In the superconducting magnetic suspension device described above, the current lead of the room temperature current lead joint is welded to the current lead of the high temperature superconducting current lead joint; the current lead of the high temperature superconducting current lead joint and the current lead of the low temperature superconducting current lead joint are connected with each other through a superconducting joint.

In the superconducting magnetic suspension device described above, multiple seal bores are provided at the center of a seal flange of the low temperature superconducting current lead joint, wherein the seal bores, with the current leads passing through the seal bores, are completely filled with a sealing medium, and the current leads and the liquid helium container are connected and sealed by screws placed in screw holes on the sealing flange.

Compared with the prior art, the present invention has the following advantages: the superconducting magnetic suspension device may realize zero volatilization of liquid helium in the liquid helium container, so that it is not necessary to perform multiple liquid helium conveying processes, enabling the superconducting magnetic suspension device to operate independently for a long period of time accordingly.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure. Exemplary embodiments of this disclosure are given for the purpose of illustrating the present disclosure, which are not limits of the present disclosure, in the figures:

FIG. 1 is a schematic diagram of a superconducting magnetic suspension device according to an embodiment of this disclosure;

FIG. 2 is a schematic diagram of a current lead joint according to an embodiment of this disclosure;

FIG. 3 is a schematic diagram of a condenser according to an embodiment of this disclosure.

### DETAILED DESCRIPTION OF THE PREFERRED EMBODIMENT

Below, the present disclosure will be further described with reference to drawings and embodiments.

FIG. 1 is a schematic diagram of a superconducting magnetic suspension device according to an embodiment of this disclosure. As shown in FIG. 1, the superconducting magnetic suspension device provided in this embodiment comprises a low temperature container 1, a refrigerator 2, a cold screen 3, a liquid helium container 4, a superconducting rotor 5, suspension coils 6, a rotor chamber 7, a liquid tube 8, a room temperature current lead joint 9, a high temperature superconducting current lead joint 10, a low temperature superconducting current lead joint 11, a condenser 12, and a pole-axis displacement sensor 13. The refrigerator 2 is assembled above the low temperature container 1. The superconducting rotor 5 is placed in the interior of the rotor chamber 7. Suspension coils 6 are disposed on the upper and lower surfaces within the rotor chamber 7. The condenser 12 is mounted at a center position above the rotor chamber 7. The pole-axis displacement sensor 13 is placed at a center position on the top of the superconducting rotor 5 within the rotor chamber 7. A probe of the pole-axis displacement sensor 13 points to the top surface of the superconducting rotor 5. The cylindrical cold screen 3 is fixed under a primary cooling head of the refrigerator 2. The liquid helium container 4 is placed in the cold screen 3 and is fixed under a secondary cooling head of the refrigerator 2. The liquid tube 8 is mounted on top of the low temperature container 1, with a lower end of the liquid tube 8 extending into the interior of the liquid helium container 4. A suspension force is produced by the interaction of an electromagnetic field generated by the suspension coils and the superconducting rotor to cause the superconducting rotor to suspend therein.

The room temperature current lead joint 9 is mounted on the upper surface of the low temperature container 1. A lead on the upper side of the room temperature current lead joint 9 is connected to a power source and a lead on the lower side of the room temperature current lead joint 9 is connected to a lead on the upper side of the high temperature superconducting current lead joint 10. The high temperature superconducting current lead joint 10 is mounted on the cold screen 3 and is cooled by the primary cold head of the refrigerator 2, so that the lead of the high temperature superconducting current lead joint is in a superconducting state. A current lead on the lower side of the high temperature superconducting current lead joint 10 is connected to the current lead on the upper side of the low temperature superconducting current lead joint 11, and the low temperature superconducting current lead joint 11 is mounted on an upper cover of the liquid helium container 4. The low temperature superconducting current lead joint 11 is cooled by the liquid helium container 4, so that the lead of the low temperature superconducting current lead joint 11 is in a superconducting state. The lead on the lower side of the low temperature superconducting current lead joint 11 is connected to the suspension coils 6. The superconducting current leads are in a superconducting state without resistance and do not produce heat when there is a current passing through those current leads. The current leads of the room temperature current lead joint 9 are formed of metal wires, the current leads of the high temperature superconducting current lead joint 10 are formed of high temperature superconducting robs, and the current leads of the low temperature superconducting current lead joint 11 are formed of Niobium-titanium alloy superconducting wires. The current lead of the room temperature current lead joint 9 is welded to the current lead of the high temperature superconducting current lead joint 10 through a welding joint 15. The welding joint 15 has a very low resistant value. The current lead of the high temperature superconducting current lead joint 10 is connected to the current lead of the low temperature superconducting current lead joint 11 by a superconducting joint 14 through superconducting soldering or direct crimping. The superconducting joint 14 has no resistance and does not produce head when there is a current passing through the joint. Heat produced by the current leads when a current is applied to the suspension coils 6 through the room temperature current lead joint 9, the high temperature superconducting current lead joint 10, the low temperature superconducting current lead joint 11 may not be conducted into the liquid helium container 4, which may reduce the volatilization of liquid helium 15 in the liquid helium container 4.

In a superconducting magnetic suspension device provided according to the above embodiment of the present disclosure, heat produced by the current leads when a current is applied to the suspension coils through the room temperature current lead joint, the high temperature superconducting current lead joint, the low temperature superconducting current lead joint may not be conducted into the liquid helium container, which may reduce the volatilization of liquid helium in the liquid helium container. Helium in the condenser is liquidized by the refrigerator to realize zero volatilization of liquid helium contained in the liquid helium container. Thereby, without the need of multiple liquid helium conveying processes, the superconducting magnetic suspension device may operate independently for a long period of time.

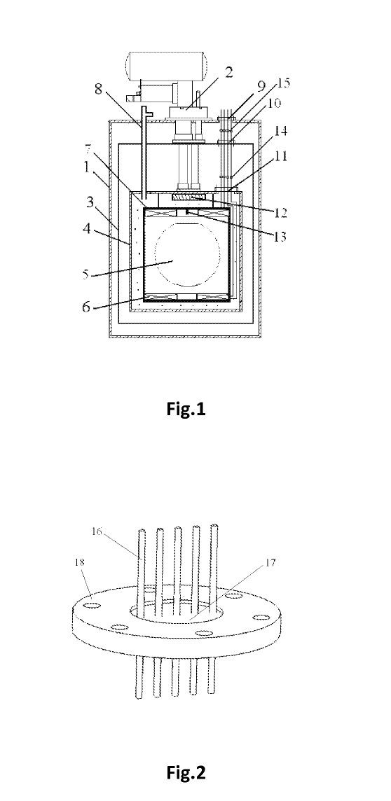

FIG. 2 is a schematic diagram of a current lead joint according to an embodiment of this disclosure. As shown in FIG. 2, for the room temperature current lead joint 9, the high temperature superconducting current lead joint 10 and the low temperature superconducting current lead joint 11, they have the same seal medium 17 and seal flange 18, except different current leads 16. For the low temperature superconducting current lead joint 11, multiple seal bores are provided at the center of the seal flange 18. The seal bores, with current leads 16 passing through the bores, are completely filled with the seal medium 17 to be sealed exactly. The lower surface of the sealing flange 18, i.e., its sealing surface must be flat enough, and the current leads 16 are connected to and sealed with liquid helium container 4 with screws placed in screw holes on the sealing flange 18.

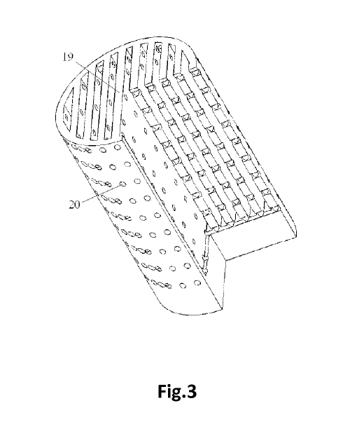

FIG. 3 is a schematic diagram of a condenser according to an embodiment of this disclosure. As shown in FIG. 3, the condenser 12 is formed of a metal material having good heat conductivity. The condenser 12 is in a cylindrical shape, and there are multiple rectangular heat-conducting splines 19 that are separated by a gap provided therein. A plurality of air vents 20 are provided on the external surface of the condenser 12 and the heat-conducting splines 19. When there is a small amount of liquid helium volatilization in the liquid helium container 4, through cooling the condenser 12 by the refrigerator 2, the volatilized helium is liquidized when contacting with the condenser 12 and then flows back to the liquid helium container 4, so that the amount of liquid helium in the liquid helium container 4 may be kept to realize zero liquid helium volatilization in the liquid helium container 4.

Notice that the above embodiment is merely used to explain the technical solution of the present invention and is not any limit thereof. Although the present invention has been described in detail according to a preferred embodiment of the present invention, those skilled in the art may understand that modifications may be made to particular implementations of the present invention or some equivalent substitutions may be made for some technical features without departing from the spirit of the technical solution of the present invention, which shall be all encompassed in the scope of the technical solution of this invention.

1. A superconducting magnetic suspension device having no substantial liquid helium volatilization, comprising: a low temperature container, a refrigerator, and a cold screen, wherein the refrigerator is mounted above the low temperature container, and the cylindrical cold screen is fixed under a primary cooling head of the refrigerator, wherein:
the superconducting magnetic suspension device further comprises a liquid helium container, a superconducting rotor, suspension coils, a rotor chamber, a liquid tube, a room temperature current lead joint, a high temperature superconducting current lead joint, a low temperature superconducting current lead joint, a condenser, and a pole-axis displacement sensor;
the liquid helium container is placed in the cold screen and is fixed under a secondary cooling head of the refrigerator;
the liquid tube is mounted above the liquid helium container with a lower end of the liquid tube extending into the liquid helium container;
the superconducting rotor is arranged in the rotor chamber, and the suspension coils are arranged on the upper and lower ends within the rotor chamber;
the pole-axis displacement sensor is placed at a center position on the top of the superconducting rotor within the rotor chamber, a probe of the pole-axis displacement sensor pointing downwards to a top plane of the superconducting rotor;
the rotor chamber is held at the center of the liquid helium container by a pull rod;
the condenser is placed at a center position above the rotor chamber in the interior of the liquid helium container;
the room temperature current lead joint is mounted on the top surface of the low temperature container;
a lead on an upper side of the room temperature current lead joint is connected to a power source and a lead on an lower side of the room temperature current lead joint is connected to a lead on an upper side of the high temperature superconducting current lead joint;
the high temperature superconducting current lead joint is mounted on the top surface of the cold screen and is cooled by the cold screen, so that the current lead of the high temperature superconducting current lead joint is in a superconducting state;
a lead on a lower side of the high temperature superconducting current lead joint is connected to a lead on an upper side of the low temperature superconducting current lead joint, the low temperature superconducting current lead joint is mounted on an upper cover of the liquid helium container; the low temperature superconducting current lead joint is cooled by the liquid helium container, so that the current lead of the low temperature superconducting current lead joint is in a superconducting state;
a lead on a lower side of the low temperature superconducting current lead joint is connected to the suspension coils.

2. The superconducting magnetic suspension device according to claim 1, wherein the condenser has a cylindrical shape, multiple rectangular heat-conducting splines that are separated by gaps are provided in the condenser; a plurality of air vents are provided in the external surface of the condenser and the heat-conducting splines; and the condenser is formed of a metal material.

3. The superconducting magnetic suspension device according to claim 1, wherein the current leads of the room temperature current lead joint are formed of metal wires, the current leads of the high temperature superconducting current lead joint are formed of high temperature superconducting bars, and the current leads of the low temperature superconducting current lead joint are formed of low temperature superconducting wires.

4. The superconducting magnetic suspension device according to claim 1, wherein the current lead of the room temperature current lead joint is welded to the current lead of the high temperature superconducting current lead joint; the current lead of the high temperature superconducting current lead joint and the current lead of the low temperature superconducting current lead joint are connected with each other through a superconducting joint.

5. The superconducting magnetic suspension device according to claim 1, wherein multiple seal bores are provided at the center of a seal flange of the low temperature superconducting current lead joint, wherein the seal bores, with the current leads passing through the seal bores, are completely filled with a sealing medium, and the current leads and a liquid helium container are connected and sealed by screws placed in screw holes on the sealing flange.

6. The superconducting magnetic suspension device according to claim 3, wherein multiple seal bores are provided at the center of a seal flange of the low temperature superconducting current lead joint, wherein the seal bores, with the current leads passing through the seal bores, are completely filled with a sealing medium, and the current leads and a liquid helium container are connected and sealed by screws placed in screw holes on the sealing flange.
